(19) United States
(12) Patent Application Publication
(10) Pub. No.: US 2019/0064992 A1
(43) Pub. Date: Feb. 28, 2019

(54) DISPLAY DEVICE

(71) Applicant: Onkyo Corporation, Osaka (JP)

(72) Inventor: Tokinori TADA, Osaka (JP)

(21) Appl. No.: 16/020,601

(22) Filed: Jun. 27, 2018

(30) Foreign Application Priority Data
Aug. 25, 2017 (JP) 2017-161962

(51) Int. Cl. G06F 3/041; G06F 3/01; G06F 3/0482; G06F 3/0488; G09G 3/20

(52) U.S. Cl. CPC G06F 3/0416; G06F 3/0412; G09G 3/20; G06F 3/0482; G06F 3/04883; G06F 3/018

(57) ABSTRACT

A display device comprising: circuitry configured to display an index list which indicates initials of attribution information of contents when it receives operation from one direction to the other direction.

### CROSS-REFERENCE TO RELATED APPLICATIONS

This application claims priority to Japanese Application No. 2017-161962, filed Aug. 25, 2017, the entire contents of which are incorporated herein by reference.

### FIELD

The present disclosure relates to a display device which displays attribute information such as titles of contents.

### BACKGROUND

As a display section, in a device which includes an LCD (Liquid Crystal Display), there are cases where a touch panel which is linked with the LCD is included in the device. In the device on premise of operation by the touch panel, in UI (user interface) which selects one from a number of sorted items (for example, contents), as method which moves to the position of an item which begins with a specific character quickly, “index list” is used. In the index list, in edge of a screen, for example, initials “A, B, C . . . ”of titles of contents are displayed vertically. In JP-T-2015-51731, initials of contact addresses are displayed on a screen vertically, and a user can jump to contact address which begins with a specific character by selecting the specific character.

In the device in which a screen is small, it is only possible to jump to very rough position because the number of characters which can be displayed as the index list is small. There are cases where characters are not displayed but it is possible to be able to move a finger on the index list up and down. Interval of characters is narrow in a small screen. For this reason, when the finger is released, there are many cases where another character is selected and operation is difficult.

Further, generally, Japanese Hiragana/Katakana and so on are not included in index list. Jump cannot be performed because order of Japanese Kanji cannot be understood. For this reason, in items which include a lot of these characters, a user have to perform many scroll after all.

### SUMMARY OF THE INVENTION

According to one aspect of the disclosure, there is provided a display device comprising: circuitry configured to display an index list which indicates initials of attribution information of contents when it receives operation from one direction to the other direction.

### BRIEF DESCRIPTION OF THE DRAWINGS

FIG. 1 is a diagram illustrating a block diagram of a configuration of a digital audio player according to an embodiment of the present invention.

FIG. 2 is a diagram illustrating a contents list screen which displays contents by list form (first embodiment).

FIG. 3 is a diagram illustrating an index list screen which displays an index list (first embodiment).

FIG. 4 is a diagram illustrating the index list screen (first embodiment).

FIG. 5 is a diagram illustrating the index list screen (first embodiment).

FIG. 6 is a diagram illustrating the index list screen (first embodiment).

FIG. 7 is a diagram illustrating the contents list screen (first embodiment).

FIG. 8 is a diagram illustrating a contents list screen (second embodiment).

FIG. 9 is a diagram illustrating a display screen that a contents list and an index list are displayed (second embodiment).

FIG. 10 is a diagram illustrating a display screen that the contents list and the index list are displayed (second embodiment).

FIG. 11 is a diagram illustrating a display screen which the index list is displayed (second embodiment).

FIG. 12 is a diagram illustrating a display screen which the index list is displayed (second embodiment).

FIG. 13 is a diagram illustrating a display screen which the index list is displayed (second embodiment).

### DETAILED DESCRIPTION OF THE PREFERRED EMBODIMENTS

An objective of the present invention is to provide a device that a user can select content easily.

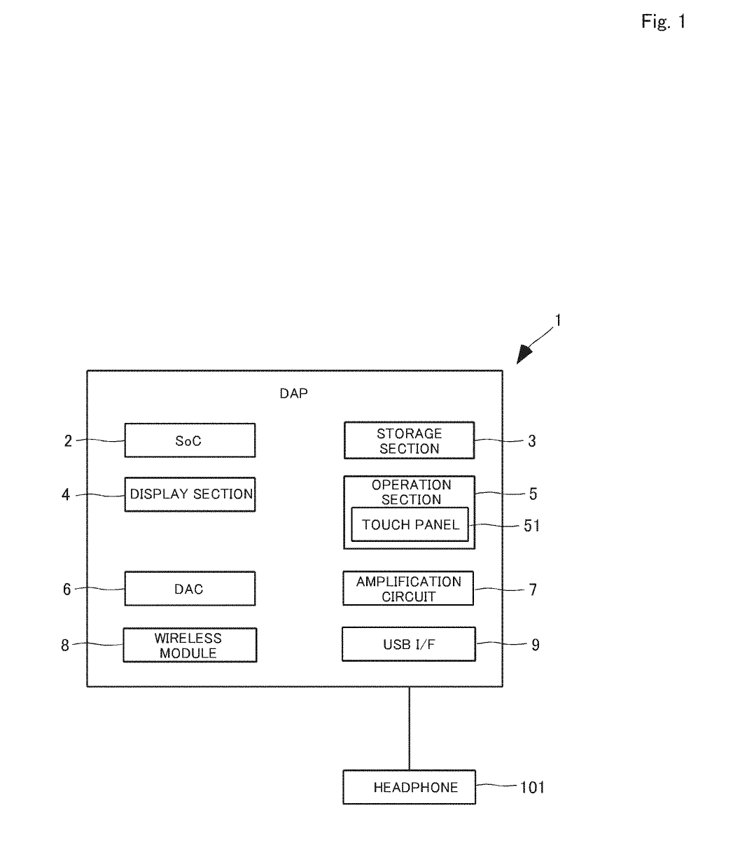

An embodiment of the present disclosure is described below. FIG. 1 is a block diagram illustrating a configuration of a digital audio player according to an embodiment of the present invention. The digital audio player (hereinafter referred as to “DAP”) 1 outputs analog audio data to a headphone 101. The headphone 101 outputs an audio based on analog audio data outside.

As illustrated in FIG. 1, the DAP 1 (display device) includes an SoC (System on Chip) 2, a storage section 3, a display section 4, an operation section 5, a D/A converter (hereinafter referred as to “DAC”) 6, an amplifier 7, a wireless module 8, and a USB interface (hereinafter referred as to “USB I/F”) 9.

The SoC 2 (controller) has a CPU (Central Processing Unit), a DSP (Digital Signal Processor), a memory and so on, and controls respective sections composing the DAP 1. The storage section 3 is composed of a flash memory which stores an OS program, programs such as application programs, and various data such as digital audio data (contents). The storage section 3 is not limited to illustrated composition, and may be an HDD (Hard Disk Drive) or the like.

The display section 4 displays various images (including still images and moving images) and is composed of a liquid crystal panel. The operation section 5 includes operation keys which are for performing various settings and a touch panel 51 which is linked with the display section 4. The touch panel 51 is provided on the display section 4. The touch panel 51 is configured to receive touch action, slide action, and so on. A user can perform various characters input, settings and so on via the operation section 5.

The SoC 2 outputs digital audio data of I2S system to the DAC 6. The DAC 6 D/A-converts digital audio data to analog audio data. Analog audio data from the DAC 6 is input to an amplifier 7. The amplifier 7 amplifies analog audio data which is D/A-converted by the DAC 6 and outputs amplified analog audio data to the headphone 101.

The wireless module 10 is for performing wireless communication according to Bluetooth® standard and Wi-Fi standard. The USB I/F 11 is for performing communication according to USB standard.

### First Embodiment

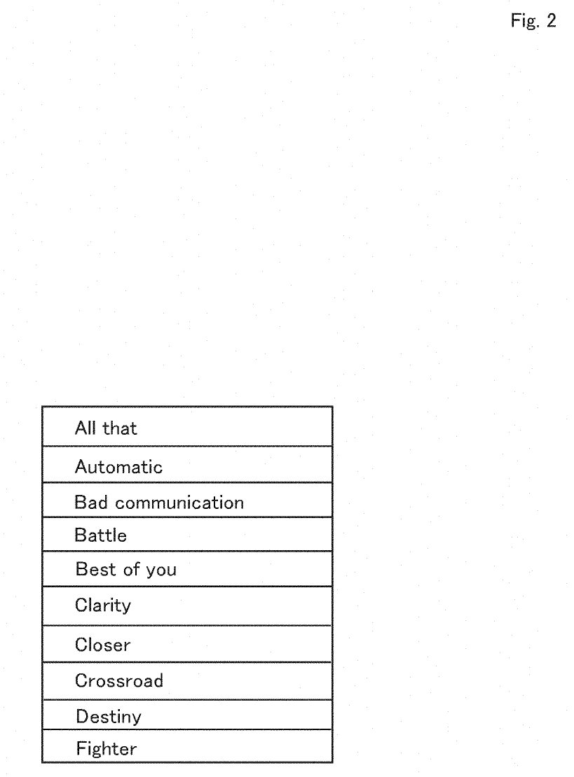

FIG. 2 is a diagram illustrating a contents list screen which displays contents by list form. As illustrated in FIG. 2, for example, the SoC 2 displays titles (attribute information) of contents (songs) which are stored in the storage section 3 by list form. In the present embodiment, the SoC 2 displays titles of contents by list, and also displays tiles of albums, artist names, and so on. Songs, moving images, and still images are included in contents.

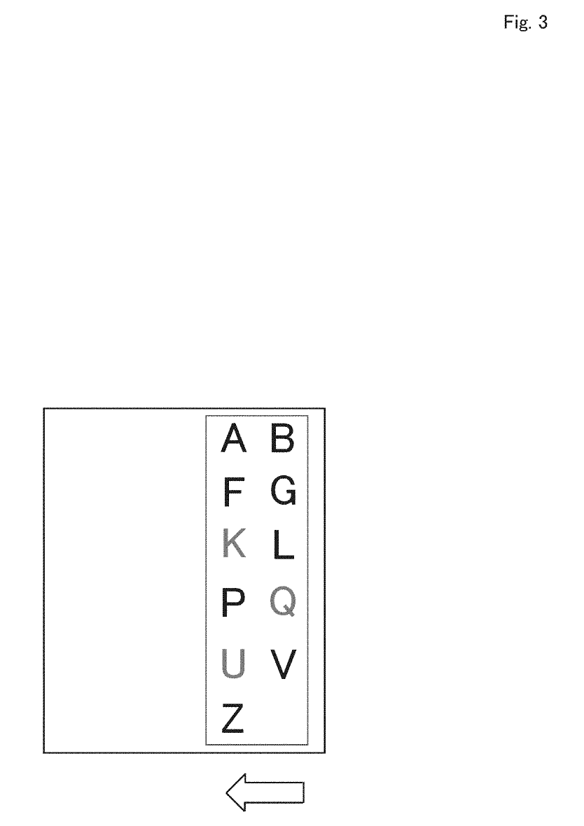

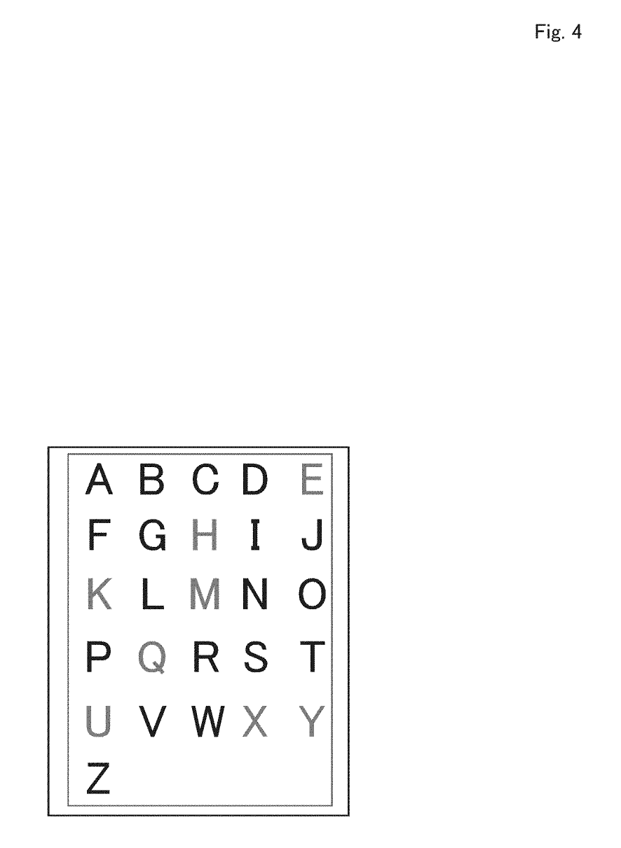

In a state which is illustrated in FIG. 2, when the SoC 2 receives swipe operation from right end (one end) (one direction) of a rectangle display screen to left direction (opposite direction) (the other direction) by the touch panel 51, as illustrated in FIG. 3, the SoC 2 displays an index list which indicates initials of titles of contents. The SoC 2 displays the index list with sliding from right end of the display screen to left direction. First, the SoC 2 displays alphabets as the index list. For example, “A” of alphabet indicates that initials of titles of contents are “A”. The SoC 2 displays 26 alphabets with sliding from right end of the display screen to left direction gradually. Finally, as illustrated in FIG. 4, the SoC 2 displays all of 26 alphabets. The SoC 2 displays the index list in matrix.

In an index list screen which displays the index list, 5 characters of alphabets are lined up from left to right in one row. The SoC 2 changes display mode of initials of titles of contents which do not exist (are not stored in the storage section 3) in alphabets. In the present embodiment, the SoC 2 grays out initials of titles of contents which do not exist. For example, in FIG. 4, alphabet “E” is displayed by gray, and it is indicated that initials “E” of titles of contents do not exist (are not stored in the storage section 3).

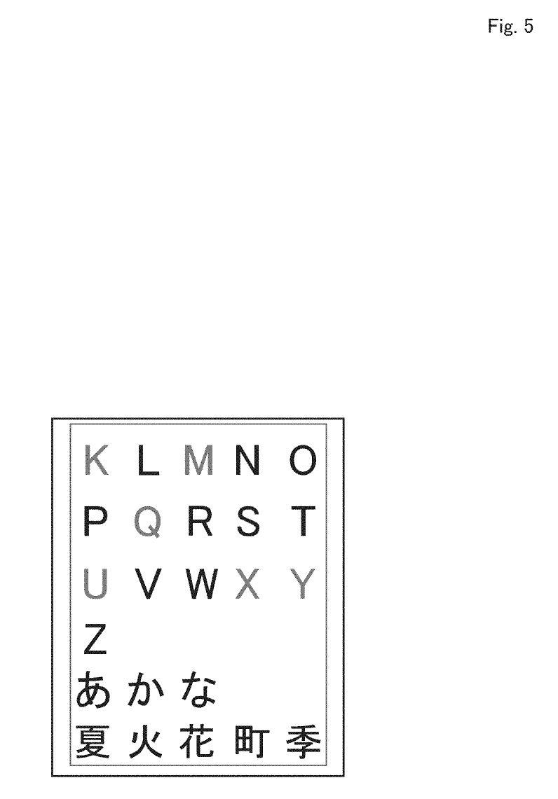

In a state which is illustrated in FIG. 4, when the SoC 2 receives swipe operation of up direction, the SoC 2 scrolls the index list screen to up direction as illustrated in FIG. 5. The SoC 2 displays Japanese Hiragana under alphabets. In Japanese Hiragana, the SoC 2 displays first character of column to which initials (“a”, “ka”, “sa”, “ta”, “na”—) of titles of contents which exist (are stored in the operation section 3) belongs among 50 sounds. For example, Japanese Hiragana “a” indicates that initials of titles is contents belong to “a” column. Namely, it is indicated that initials of titles are any one of “a” to “o”. In Japanese Hiragana, first character of column to which initials of titles of contents which do not exist belongs is not displayed. For example, in FIG. 4, Japanese Hiragana “sa” is not displayed. Contents in which initials of titles are “sa” to “so” belong to “sa” column do not exist.

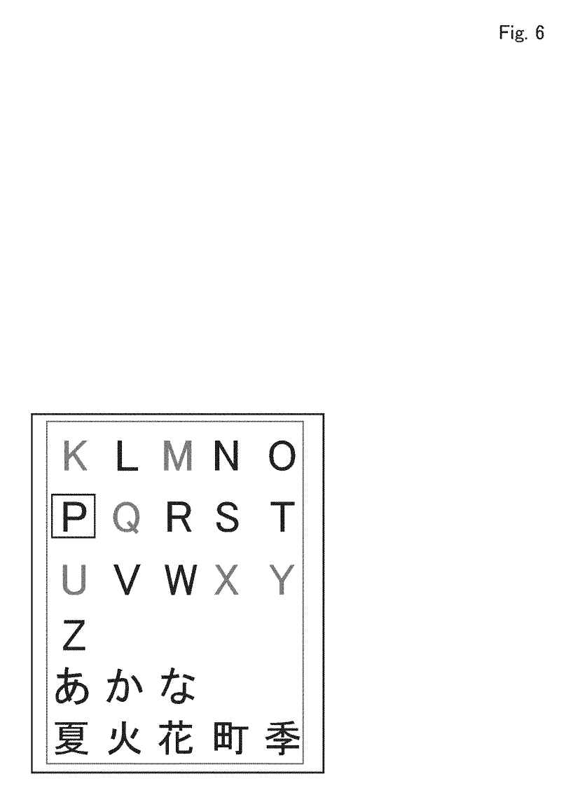

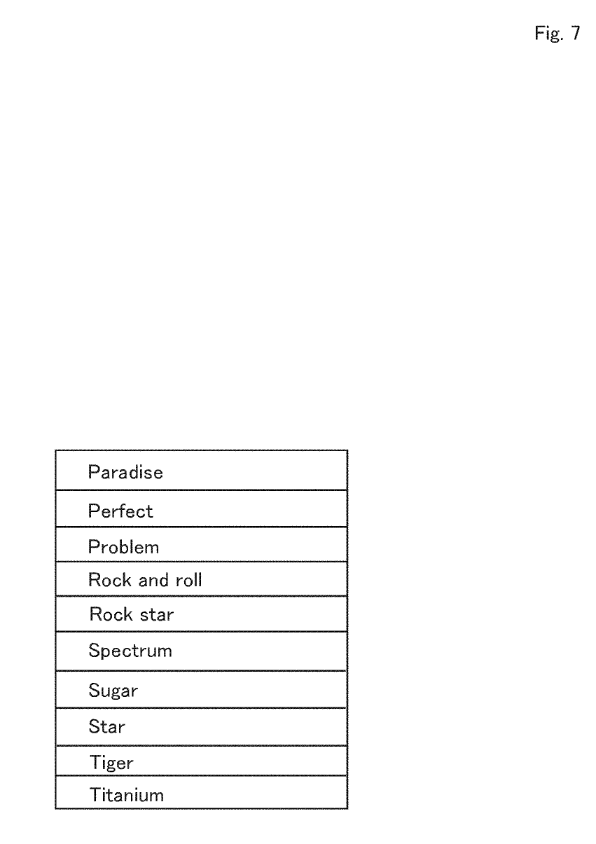

As illustrated in FIG. 5, the SoC 2 displays Japanese Kanji under Japanese Hiragana. In Japanese Kanji, order is not decided. For this reason, the SoC 2 displays all of initials of titles of contents which exist (are stored in the storage section 3). In a state which is illustrated in FIG. 5, when the SoC 2 receives swipe operation of down direction, the SoC 2 scrolls the index list screen to down direction. Therefore, in the index list screen, when the SoC 2 receives swipe operation of up or down direction, the SoC 2 scrolls the index list screen to up or down direction. In a state which is illustrated in FIG. 5, for example, as illustrated in FIG. 6, when the SoC 2 receives selection of alphabet “P” by the touch panel 51, as illustrated in FIG. 7, the Soc 2 displays a contents list screen on which contents are lined up from contents in which initials of titles are “P” in order. Namely, when the SoC 2 receives selection of initial, the SoC 2 returns to the contents list screen. The index list is not displayed usually. When the SoC 2 receives above described swipe operation, the index list is displayed.

As described above, in the present embodiment, when the SoC 2 receives swipe operation from right end of the display screen to left direction by the touch panel 51, the SoC 2 displays the index list which indicates initials of titles of contents. Thus, the user can select character of the index list easily. Further, when the SoC 2 receives selection of character of the index list, the SoC 2 displays a screen on which contents are lined up. The contents are displayed in order from contents that the initial of title is a character of which the selection is received by the SoC 2. Thus, after the user selects a character from the index list, the user can select content from displayed contents which is lined up easily.

Further, in the present embodiment, the SoC 2 changes display mode of initials of titles of contents which are not stored in the storage section 3 in alphabets. Concretely, the SoC 2 grays out initials of titles of contents. Thus, the user can understand that contents are not stored in the storage section 3, because the contents of which initials of titles are the grayed out character.

### Second Embodiment

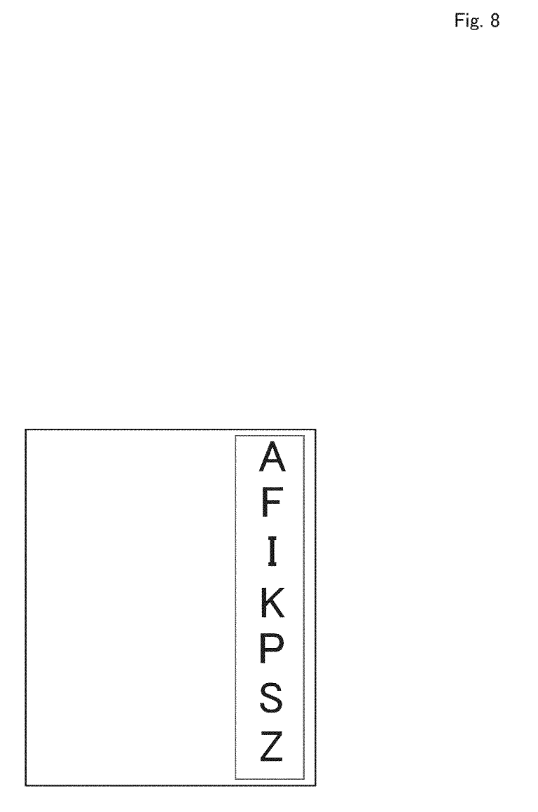

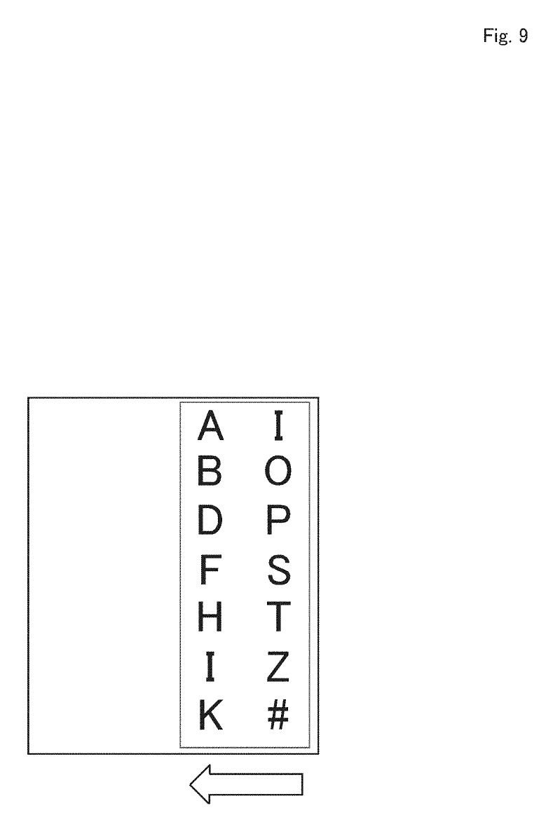

In a second embodiment, the SoC 2 displays the index list of a part of alphabets in a contents list screen. As illustrated in FIG. 8, the SoC 2 displays a part of alphabets on right end of the contents list vertically. In default, a part of alphabets is displayed so that scroll amount of A to Z is average. As illustrated in FIG. 8, alphabets are displayed in one row. Seven characters of alphabets are displayed in one row from top to bottom. When the SoC 2 receives swipe operation to opposite direction (left direction) of a screen against the index list, as illustrated in FIG. 9, the SoC 2 enlarges display area of the index list. The SoC 2 increases the number of rows (the number of display) to display the index list according to expansion of display area of the index list. In FIG. 9 from FIG. 8, the number of displayed rows is increased from one row to two rows.

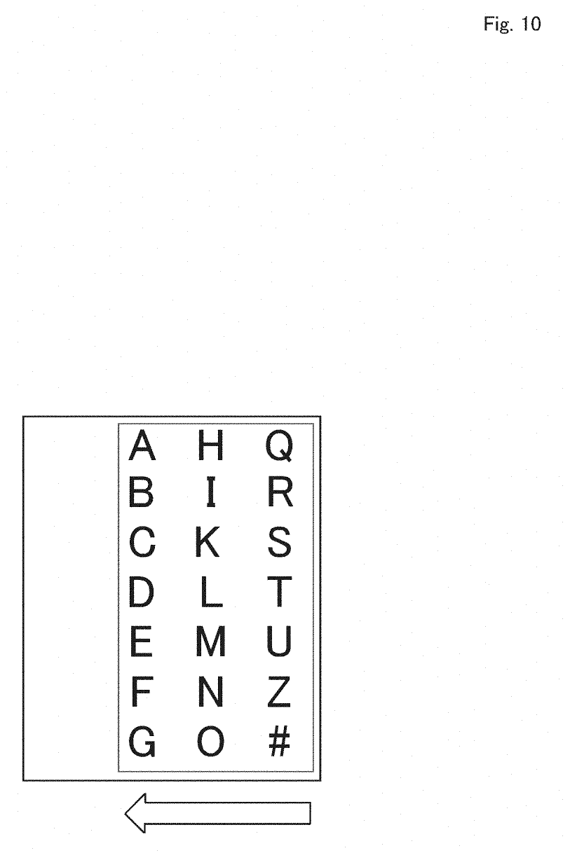

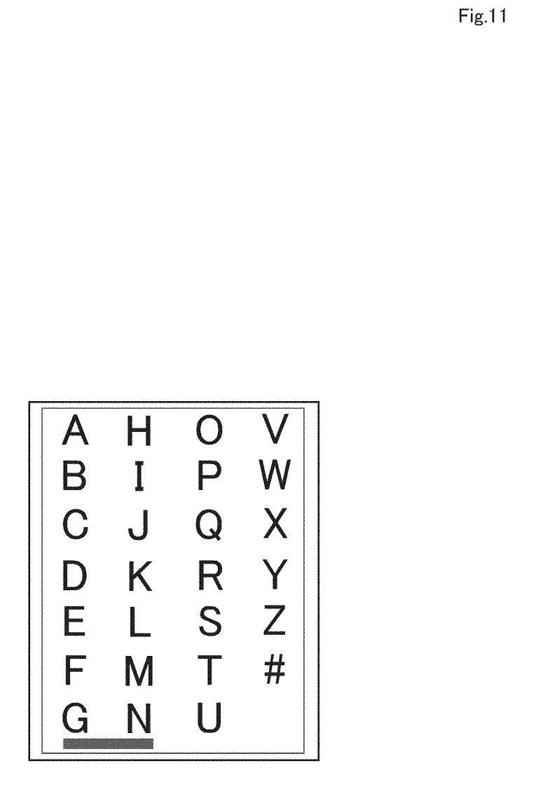

When the SoC 2 further receives swipe operation, as illustrated in FIG. 10, the SoC 2 further enlarges display area of the index list and increases the number of rows to display the index list. In FIG. 10 from FIG. 9, the number of displayed rows is added from two rows to three rows. When the SoC 2 further receives swipe operation, as illustrated in FIG. 11, the SoC 2 enlarges display area to entire screen and increases the number of rows to display the index list to the entire screen. In FIG. 11 from FIG. 10, the number of displayed rows is added from three rows to four rows. In FIG. 11, all of alphabets are displayed.

When the index list becomes maximum size, namely, the SoC 2 displays all of alphabets, the SoC 2 receives swipe operation in the horizontal direction of the index list. The SoC 2 displays a scroll bar under the index list, and receives swipe operation in the horizontal direction of the index list. In a state which is illustrated in FIG. 11, when the Soc 2 receives swipe operation in the horizontal direction by the scroll bar, the SoC 2 scrolls the index list in the horizontal direction, and displays Japanese Hiragana, Japanese Katakana, Japanese Kanji and so on. The SoC 2 displays the index list in matrix.

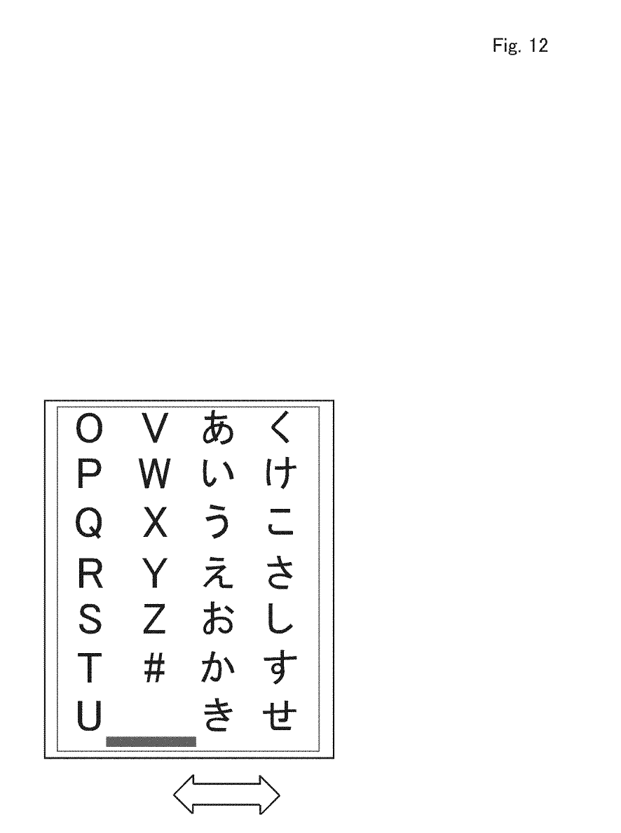

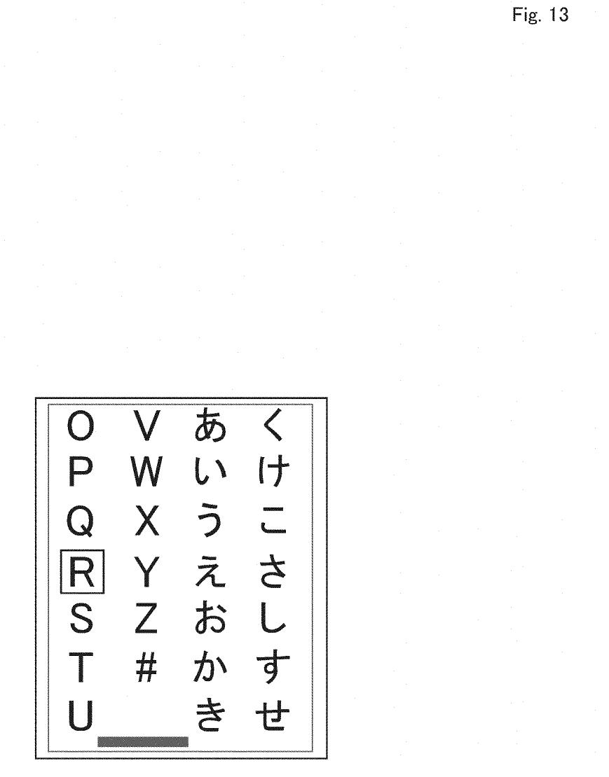

In a state which is illustrated in FIG. 12, for example, as illustrated in FIG. 13, the SoC 2 receives selection of alphabet “R” by the touch panel 51, the Soc 2 displays a contents list screen on which contents are lined up from contents in which initials of titles are “R” in order. Namely, when the SoC 2 receives selection of initials, the Soc 2 returns to the contents list screen.

As described above, in the present embodiment, when the SoC 2 receives operation against the index list by the touch panel 51, the SoC 2 enlarges display area of the index list and increases the number of display of the index list. Thus, it is easy for the user to select characters of the index list. Further, when the SoC 2 receives selection of character of the index list, the SoC 2 displays a screen on which contents are lined up. The contents are displayed in order from contents that the initial of title is a character of which the selection is received by the SoC 2. Thus, after the user selects character from the index list, the user can select content from displayed contents which is lined up easily.

The embodiments of the present invention are described above, but the mode to which the present invention is applicable is not limited to the above embodiments and can be suitably varied without departing from the scope of the present invention.

In the above described first embodiment, when the SoC 2 receives swipe operation from right end of the display screen to left direction, the SoC 2 displays the index list. Not limited to this, when the SoC 2 receives swipe operation from left end of the display screen to right direction, the SoC 2 may display the index list. In this case, the SoC 2 displays the index list with sliding the index list from right end of the display screen to left direction. Further, when the SoC 2 receives swipe operation from up end or down end of the display screen to down direction or up direction, the SoC 2 may display the index list. In this case, the SoC 2 displays the index list with sliding from up end or down end of the display screen to down direction or up direction.

In the above described first embodiment, the SoC 2 grays out initials of titles of contents which are not stored in the storage section 3 as change of display mode. Not limited to this, the SoC 2 may not display initials of titles of contents which are not stored in the storage section 3 and may mark X marks on initials.

In the above described embodiments, as a device which functions as a display device, the DAP is illustrated. Not limited to this, the display device may be a smartphone, a tablet PC or the like other than the DAP.

The present disclosure can be suitably employed in a display device which displays attribute information such as titles of contents.

What is claimed is:

1. A display device comprising:
circuitry configured to display an index list which indicates initials of attribution information of contents when it receives operation from one direction to the other direction.

2. The display device according to claim 1,
wherein the circuitry displays the index list when it receives operation from one end of a display screen to opposite direction.

3. The display device according to claim 2,
wherein the circuitry displays the index list from one end of the display screen to opposite direction with sliding.

4. The display device according to claim 1,
wherein the circuitry displays alphabets as the index list first.

5. The display device according to claim 4,
wherein the circuitry displays all of alphabets as the index list.

6. The display device according to claim 5,
wherein the circuitry displays Japanese Hiragana and Japanese Kanji in order or Japanese Kanji and Japanese Hiragana in order after it displays all of alphabets.

7. The display device according to claim 4,
wherein the circuitry stores contents, and changes display mode of initials of attribution information of contents which are not stored in the circuitry in alphabets.

8. The display device according to claim 7,
wherein the circuitry grays out initials of attribution information of contents which are not stored in the circuitry as change of display mode.

9. The display device according to claim 6,
wherein the circuitry displays a first character of a column to which initials of attribution information of contents which are stored in the circuitry belongs among 50 sounds in Japanese Hiragana.

10. The display device according to claim 6,
wherein the circuitry displays initials of attribution information of contents which are stored in the circuitry in Japanese Kanji.

11. The display device according to claim 1,
wherein the circuitry displays a screen on which contents are lined up, in order from contents of which an initial of attribution information is a character whose selection is received when it receives selection of character of the index list.

12. A display device comprising:
a display section;
a touch panel; and
a controller,
wherein the controller displays an index list which indicates initials of attribution information of contents on the display section when it receives operation from one direction to the other direction by the touch panel.

13. A display device comprising:
circuitry configured to display a part of an index list which indicates attribution information of contents, and
enlarge a display area of the index list and increase the number of display of the index list when it receives operation against the index list.

14. A display device comprising:
a display section;
a touch panel; and
a controller,
wherein the controller displays a part of an index list which indicates attribution information of contents on the display section, and
enlarges a display area of the index list and increases the number of display of the index list when it receives operation against the index list by the touch panel.

15. A storage medium in which a control program of a display device which comprises circuitry, the control program of the display device allows the circuitry to display an index list which indicates initials of attribution information of contents when it receives operation from one direction to the other direction.

16. A storage medium in which a control program of a display device which comprises circuitry, the control program of the display device allows the circuitry to display a part of an index list which indicates attribution information of contents, and
to enlarge display area of the index list and increase the number of display of the index list when it receives operation against the index list.
